(19) United States
(12) Patent Application Publication
(10) Pub. No.: US 2024/0223706 A1
(43) Pub. Date: Jul. 4, 2024

(54) Specialized Microbots in Contact Centers

(71) Applicant: Avaya Management L.P., Durham, NC (US)

(72) Inventors: Harsh V. Mendiratta, East Brunswick, NJ (US); Reinhard P. Klemm, West New York, NJ (US); Elizabeth Harrington, Long Beach, NY (US); James McTiernan, Venus, PA (US)

(21) Appl. No.: 18/401,318

(22) Filed: Dec. 29, 2023

Related U.S. Application Data
(60) Provisional application No. 63/436,478, filed on Dec. 30, 2022.

(51) Int. Cl. H04M 3/523

(52) U.S. Cl. CPC H04M 3/5232

(57) ABSTRACT

Large monolithic virtual agents attempt to provide all skills and abilities in a contact center in order to resolve a work item (call) from a customer. However, as the issues become more complex this paradigm results in errors, inefficiencies and knowledge shortcomings on the information and data they have been trained with. Accordingly, systems and methods are provided that enable a number of individual specialized virtual agents, working together, to be deployed. Each has a finite set of abilities and a communication may be transferred to the particular specialized virtual agent having the ability required to resolve a work item. A discovery service is provided to enable an agent to identify particular specialized virtual agent(s) having the required ability in order to resolve the work item, part of the work item or multiple work items.

### CROSS-REFERENCE TO RELATED APPLICATIONS

The present application claims the benefit of Provisional Patent Application No. 63/436,478, filed on Dec. 30, 2022, and is incorporated herein by reference in its entirety.

### FIELD OF THE DISCLOSURE

The invention relates generally to systems and methods for specialized virtual agents and to the discovery thereof.

### BACKGROUND

Contact centers commonly utilize live (i.e., human) agents to interact with customers. Each agent has a different set of skills and capabilities. Some agents are highly sought after because they have significant skills and experience. Incoming calls may be connected directly to an agent or initially assessed for topic and complexity before being routed to an appropriate agent or pool of agents. Calls coming into the contact center differ, and many calls do not need an agent with significant skills and experience (often called a subject matter expert (SME)). There is typically a larger pool of less skilled agents who take the majority of the initial calls (e.g., Tier 1). They often reach out to the SME agents when specialized assistance is required or a call is required to be escalated to a higher Tier.

For contact centers utilizing virtual agents, the agents can also vary in terms of skills and abilities. There are simple virtual agents used by contact centers to handle simple calls, usually pre-programmed responses. The simple virtual agents are able to process calls that require simple responses/answers and/or the initial processing for a more complex calls. For customers with a specialized issue, if only using simple virtual agents, they may end up in an unproductive interaction that reaches no resolution. Using specialized microbots/agents, the call moves beyond the capabilities of the simple virtual agent, to be escalated to an SME virtual agent. The first escalation may alternately be sent to another virtual agent that has greater sophistication and skills and/or access to additional information and databases. The higher-level virtual agents may also have access to artificial intelligence (AI) routines, may have greater computing capabilities (e.g., higher central processing unit (CPU) speed), or may be hosted in a different region for security reasons. The selection of the SME virtual agent may use AI routines based on the nature and content of the current status of the call in progress, or it may be rules-based, availability-based, or use a different selection algorithm.

The state of the prior art is currently a monolithic (macro) virtual agent. Virtual agents (also called bots or chatbots) are typically made by the same team in the same company with one coherent piece of code. The one coherent piece of code attempts to perform all desired tasks to automate in all interactions with customers.

Monolithic virtual agents often evolve piecemeal, which results in a patchwork of code (e.g., “spaghetti” code). Monolithic agents attempt to do all functions or, if not, expand to cover complex tasks. Such automated agents are very expensive to create initially and difficult and expensive to maintain. Even relatively simple bots have significant portions of this tangled code, making the bots complicated and hard to fix, upgrade, troubleshoot, and maintain.

### SUMMARY

A set of specialized virtual agents is provided. Novel discovery and routing to a particular specialized virtual agent are provided, as well as an interface between the specialized virtual agents to allow invocation of one specialized virtual agent by another. Additionally, support for attributes, permissions, technical support, fee structures/billing, etc. is provided.

As a benefit, inexpensive and specialized virtual agents are provided to handle specific types of interactions as well as to replace monolithic agents. The specialized virtual agents are more modular and easier to create, test, use, and maintain. Additionally, specialized virtual agents require fewer computing resources (e.g., processing power, memory, data storage, etc.) over monolithic virtual agents, which requires all functionality to either be instantiated or be allocated and made available, regardless of what functionality will actually be needed to interact with a customer. Specialized virtual agents will typically be offered by an ecosystem of different and specialized vendors and be deployed by these vendors in public cloud computing services that allow others to use the services of the specialized virtual agents.

These and other needs are addressed by the various embodiments and configurations of the present invention. The present invention can provide a number of advantages depending on the particular configuration. These and other advantages will be apparent from the disclosure of the invention(s) contained herein.

In one embodiment, systems and methods are disclosed to create inexpensive and specialized virtual agents operable to handle specific types of interactions as well as to replace monolithic agents with a distributed collection of specialized microbot virtual agents. Monolithic agents that can do any function or expand to cover complex tasks are very expensive to create initially and difficult to change as well as expensive to use and replace over time. They become obsolete and, as a benefit of the embodiments disclosed herein, may be replaced, in whole or in part, with specialized virtual agents.

In another embodiment, specialized virtual agents are disclosed. Additionally or alternatively, supporting structures for specialized virtual agents are also disclosed. Specialized virtual agents handle specific types of interactions and may be tuned to handle their particular interactions well. The advantages include cost savings (cheaper to design and deploy by leveraging the economies of scale), efficiency, specialization, ease of design and simpler ongoing maintenance. Generally, it is better to write bots with specific purposes rather than trying to have one monolithic bot try do everything but not as well.

In another embodiment, specialized agents may be deployed in a single contact center or across multiple enterprises (e.g., different clouds, etc.). For example, one company might be a payment virtual agent that is adept at assisting a customer in entering payment information, integrated with Visa, MasterCard, American Express, PayPal, etc. A second type of virtual agent might be adept at collecting a user's address, integrated for example with the United States Postal Service or some shipping entity, including some geolocation or other location-specific ability. A third type of virtual agent may be a configurator for a complex product such as a car or computer that features many configuration parameters and that is updated in accordance with perhaps regular or frequent model changes in the underlying product. Each of these virtual agents and others may be highly specialized.

Routing and Discovery: In another embodiment, specialized virtual agent discovery systems and methods are provided. Specialized virtual agents may publish their costs (fixed or dynamically determined), features, type of work, current availability, and/or features for discovery by other specialized virtual agents or other agents (human and/or automated) to a “marketplace” discovery service that other virtual agents have access to.

Specialized virtual agents may have attributes, such as knowledge that certain interactions require a privacy level or other functionality not provided by a particular specialized virtual agent. The specialized virtual agent may also offer proper encryption capabilities or access to certain databases that the privacy of the call requires. If a call cannot be handled by one specialized virtual agent, the call is routed to another specialized virtual agent or agents that do have the required attributes.

In other embodiments, a call may be currently in processing by a regular agent, whether human or virtual, and transferred to a specialized virtual agent. In another embodiment, a specialized virtual agent may transfer the call to a regular or virtual agent.

A call may be transferred to (or from) a virtual agent based on one or more attributes. One attribute is utilization. For example, a specialized “overflow” virtual agent may be utilized, or utilized more often, if the load on a primary agent (e.g., a human agent) is over a threshold amount. Conversely, computing and network resources are not infinite. If specialized virtual agents are overwhelmed, utilization may be transferred to traditional monolithic agents and/or human agents.

In another embodiment, the specialized virtual agent is an artificial intelligence, such as a neural network. Training a neural network on a large dataset, such as to operate as a monolithic virtual agent, is time and resource intensive. In contrast, training a specialized virtual agent, implemented as a neural network, requires a much smaller dataset and, therefore, a smaller number of processing resources and/or time for training the specialized virtual agent. Flaws in training are much easier to identify and resolve if the dataset is limited to the domain of a specialized virtual agent rather than to the vast domains required by a monolithic virtual agent.

Embodiments herein may refer to the interaction between an agent, such as a specialized virtual agent, and a customer as a “call,” referring to an audio call. One of ordinary skill in the art will appreciate that other communication types (e.g., video calls, text messages, social media chats, emails, etc.) may be utilized without departing from the scope of the embodiments herein.

In some aspects, the techniques described herein relate to a system, including: a network interface to a communications network; and at least one processor coupled with a computer memory including computer-readable instructions; and wherein the at least one processor executes the computer-readable instructions to: execute a first specialized virtual agent including a first set of abilities; execute a second specialized virtual agent including a second set of abilities including at least one ability of the second set of abilities absent from at least one ability of the first set of abilities; engage the first specialized virtual agent in a communication, via the network interface, with a customer communication device utilized by a customer, wherein the communication includes content provided by the customer corresponding to a work item; and upon determining that the first set of abilities is absent a required ability required to resolve the work item, transfer the communication to the second specialized virtual agent.

In some aspects, the techniques described herein relate to a system, wherein the at least one processor executes the computer-readable instructions to further determine that the required ability matches at least one ability of the second set of abilities.

In some aspects, the techniques described herein relate to a system, wherein the at least one processor executes the computer-readable instructions to further: execute a third specialized virtual agent including a third set of abilities wherein at least one ability of the third set of abilities is absent from both the first set of abilities and the second set of abilities; and wherein transfer of the communication to the second specialized virtual agent is performed upon determining a better degree of match between the required ability to at least one ability of the second set of abilities compared to a degree of match between the required ability and the third set of abilities.

In some aspects, the techniques described herein relate to a system, wherein the first set of abilities differ from the second set of abilities in at least one ability shared between the first set of abilities and the second set of abilities differ in complexity.

In some aspects, the techniques described herein relate to a system, wherein the first set of abilities differ from the second set of abilities in at least one of available computational cycles, memory, bandwidth, or processing speed.

In some aspects, the techniques described herein relate to a system, wherein transferring the communication to the second specialized virtual agent further includes instantiating the second specialized virtual agent and transferring the communication to the second specialized virtual agent thereafter.

In some aspects, the techniques described herein relate to a system, wherein the at least one processor executes the computer-readable instructions to: execute a virtual agent discovery service; determine, by the virtual agent discovery service, that the required ability to resolve the work item is present in a data record of abilities corresponding to the second specialized virtual agent.

In some aspects, the techniques described herein relate to a system, wherein the at least one processor executes the computer-readable instructions to: execute a virtual agent discovery service coupled with a data storage to maintain the second set of abilities; and determining, by the virtual agent discovery service, that the required ability is present in the second set of abilities transferring the communication to a default agent.

In some aspects, the techniques described herein relate to a system, wherein the first set of abilities and the second set of abilities include at least one domain knowledge ability, product knowledge ability, technical skill ability, language ability, communication type ability, secure communication ability, and wait time.

In some aspects, the techniques described herein relate to a method, including: executing a first specialized virtual agent including a first set of abilities; executing a second specialized virtual agent including a second set of abilities including at least one ability of the second set of abilities absent from at least one ability of the first set of abilities; engaging the first specialized virtual agent in a communication, via a network, with a customer communication device utilized by a customer, wherein the communication includes content provided by the customer corresponding to a work item; and upon determining that the first set of abilities is absent a required ability that is required to resolve the work item, transferring the communication to the second specialized virtual agent.

In some aspects, the techniques described herein relate to a method, further including determining that the required ability matches at least one ability of the second set of abilities.

In some aspects, the techniques described herein relate to a method, further including: executing a third specialized virtual agent including a third set of abilities wherein at least one ability of the third set of abilities is absent from both the first set of abilities and the second set of abilities; and wherein transfer of the communication to the second specialized virtual agent is performed upon determining a better degree of match between the required ability to at least one ability of the second set of abilities compared to a degree of match between the required ability and the third set of abilities.

In some aspects, the techniques described herein relate to a method, wherein the first set of abilities differs from the second set of abilities in at least one ability shared between the first set of abilities and the second set of abilities differ in complexity.

In some aspects, the techniques described herein relate to a method, wherein the first set of abilities differ from the second set of abilities in at least one of available computational cycles, memory, bandwidth, or processing speed.

In some aspects, the techniques described herein relate to a method, wherein transferring the communication to the second specialized virtual agent further includes instantiating the second specialized virtual agent and, thereafter, transferring the communication to the second specialized virtual agent.

In some aspects, the techniques described herein relate to a method, further including: executing a virtual agent discovery service; and determining, by the virtual agent discovery service, that the required ability to resolve the work item is present in a data record of abilities corresponding to the second specialized virtual agent.

In some aspects, the techniques described herein relate to a method, further including: executing a virtual agent discovery service coupled with a data storage to maintain the second set of abilities; and determining, by the virtual agent discovery service, that the required ability is present in the second set of abilities transferring the communication to a default agent.

In some aspects, the techniques described herein relate to a method, wherein the first set of abilities and the second set of abilities include at least one domain knowledge ability, product knowledge ability, technical skill ability, language ability, communication type ability, secure communication ability, and wait time.

In some aspects, the techniques described herein relate to a computer-readable medium having instructions encoded thereon including instructions to: execute a first specialized virtual agent including a first set of abilities; execute a second specialized virtual agent including a second set of abilities including at least one ability of the second set of abilities absent from at least one ability of the first set of abilities; engage the first specialized virtual agent in a communication, via a network, with a customer communication device utilized by a customer, wherein the communication includes content provided by the customer corresponding to a work item; and upon determining that the first set of abilities is absent a required ability that is required to resolve the work item, transfer the communication to the second specialized virtual agent.

In some aspects, the techniques described herein relate to a computer-readable medium, further including instructions to: execute a virtual agent discovery service; and determine, by the virtual agent discovery service, that the required ability to resolve the work item is present in a data record of abilities corresponding to the second specialized virtual agent.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a data structure in accordance with embodiments of the present disclosure;

FIG. 4 depicts a process in accordance with embodiments of the present disclosure; and

FIG. 5 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

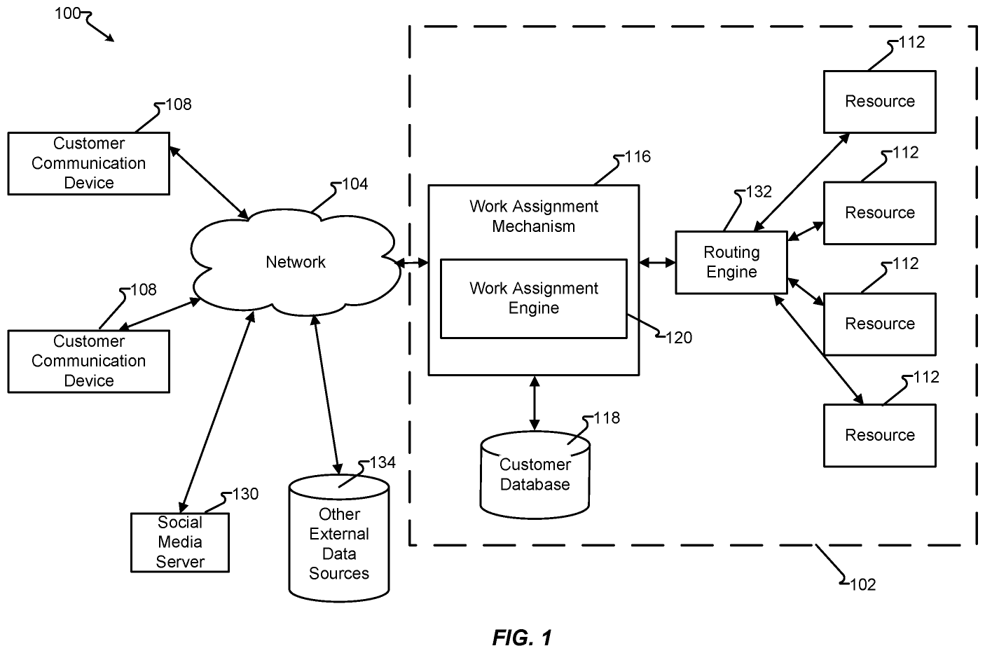

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are themselves, or are associated with, work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., a company, enterprise, etc.), and/or logical boundary (e.g., resources 112 utilized to provide services to customers for a customer of contact center 102).

Furthermore, the border illustrating contact center 102 may be as illustrated or, in other embodiments, include alterations and/or more and/or fewer components than illustrated. For example, in other embodiments, one or more of resources 112, customer database 118, and/or other components may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134, may be within contact center 102 physically and/or logically, but still be considered external for other purposes (e.g., system administration). For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through various telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VOIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as a coaxial cable, a copper cable/wire, a fiber optic cable, antennas for transmitting/receiving wireless messages, and combinations thereof.

The customer communication devices 108 may correspond to a particular customer(s). In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., a collection of servers), a media request, an application request (e.g., a request for an application resource location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed May 20, 2010, Feb. 17, 2010, and Feb. 17, 2010, respectively; each of which is hereby incorporated herein by reference in its entirety.

The format of the work item may depend upon the capabilities of the customer communication device 108 and/or the format of the communication. In particular, work items are logical representations of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or a collection of communication equipment. Examples of a suitable customer communication device 108 includes, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed among a plurality of service provider customers, one being contact center 102.

In one embodiment, a message is generated by customer communication device 108 and received via communication network 104 at work assignment mechanism 116. The message received by a contact center 102, such as at the work assignment mechanism 116, is generally, and herein, referred to as a “contact.” Routing engine 132 routes the contact to at least one of resources 112 for processing.

In another embodiment, more than one second agent 218 may be instantiated. For example, second agent 218 may be specialized, such as to resolve a credit card issue that requires security to support the exchange of credit card numbers. Second agent 218 may be instantiated on demand (e.g., upon having a call routed thereto by first agent 208). Additionally or alternatively, a number of second agents 218 may be instantiated. For example, the credit card company may know that at a particular time there are ten customers who need the services provided by second agent 218. As a result, ten instantiations of second agent 218 may be provided and ready to use. As a benefit, resources that are not needed are not instantiated. For example, a hundred instantiations of second agent 218 are not instantiated if ten are predicted to be needed.

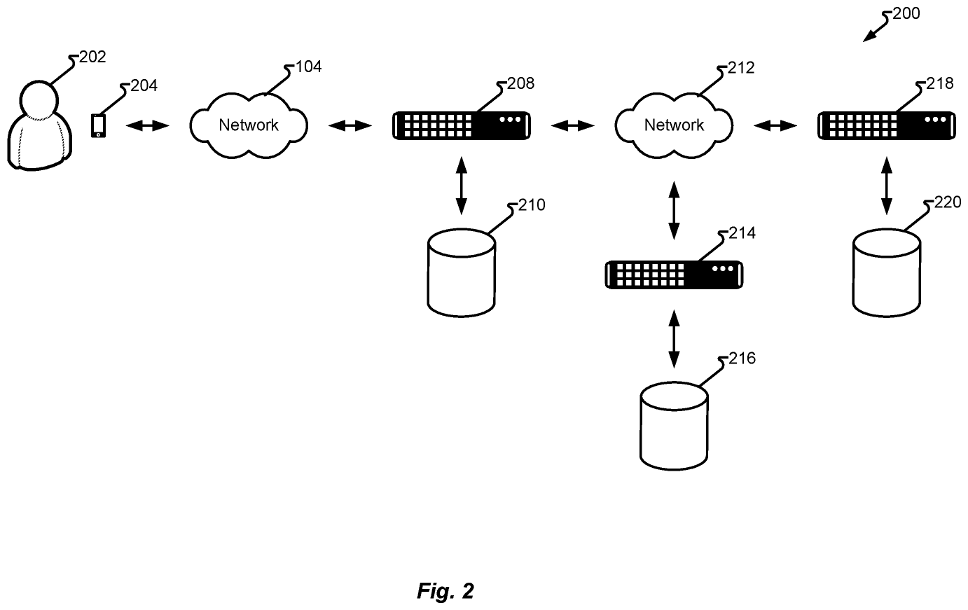

FIG. 2 depicts system 200 in accordance with embodiments of the present disclosure. System 200 illustrates a number of discrete hardware components, each performing a corresponding discrete task (i.e., at least one processor thereof executing machine instructions). System 200 is provided as one embodiment and for the promotion of clarity that results from a single component performing a single process. In other embodiments, the topography of system 200 may vary such as to include the functionality, described herein with respect to a single illustrated component, on two or more components. Similarly, and in another embodiment, the functionality, described herein with respect to two or more components, may be performed on a single component.

Customer 202, utilizing device 204, is engaged with first agent 208. It should be appreciated that first agent 208 may be an automated agent or a human agent utilizing a communication device. First agent 208 may comprise resource 112 and interact with customer 202 to resolve a work item via network 104 during a call. In other embodiments, the interaction may be another form of communication (e.g., video chat, email, text messages, social media chat, etc.). First agent 208 may be coupled to data storage 210, such as to store data regarding the operation of first agent 208. As one example, data storage 210 comprises a data record of domains that first agent 208 is able to handle. If the call with customer 202 indicates a need to include a topic outside of the domains for first agent 208, first agent 208 may transfer the call to another agent.

In one embodiment, a call that includes any domain outside of the identified domains for first agent 208 is sent to a known second agent without further processing. For example, the known second agent may be a human agent (e.g., a resource 112 when embodied as a live agent). As another example, the known second agent may be a monolithic automated agent (e.g., a resource 112 when embodied as a broad-purpose automated agent). In another embodiment, the domain that is excluded from (or not included in) the domains of first agent 208, is matched to a corresponding second agent 218 and the call with customer 202 is routed thereto. Second agent 218 has an associated record of abilities, such as domains that may be processed and/or other attributes (e.g., product knowledge, language skills, avatar for video chats, etc.) in a data storage, such as data storage 220. The abilities may be determined to be necessary to complete a work item. For example, customer 202 may call to discuss “Product A”, which is a domain attribute of first agent 208. Customer 202 may then add or change the domain (e.g., “I said Product A, but I meant Product B,” “I also have questions about Product B,” “Does anyone there speak German?” etc.). First agent 208 may have no ability to discuss “Product B”, but second agent 218 does have the ability, as recorded in data storage 210 and reported by virtual agent discovery service 214. Accordingly, the call is transferred to second agent 218.

In another embodiment, a first domain requests virtual agent discovery service 214 to identify an appropriate second agent (e.g., a pool of second agents comprising second agent 218). Virtual agent discovery service 214 may be coupled with a data storage, such as data storage 216 comprising a record of one or more second agents and attributes corresponding to each thereof. In one example, first agent 208 provides a domain, topic, word, etc., to virtual agent discovery service 214 and receives therefrom the identification of an appropriate second agent having the ability to address the domain, topic, word, etc. Virtual agent discovery service 214 may comprise, be comprised by, or utilize routing engine 132 to route the call to the appropriate second agent. In another embodiment, additional or alternative attributes are provided to virtual agent discovery service 214 to receive a corresponding second agent. For example, attributes may include a security attribute (e.g., the call requires transmission or processing of account numbers or other confidential information), availability/response time (e.g., the transferred call can be answered within five seconds), language skill, product knowledge, etc.

First agent 208 and/or second agent 218, when embodied as an automated agent, may comprise a neural network. A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., a hyperplane) to delineate a combination of inputs that are active or inactive.

A neural network may be trained with a first data set, such as a particular portion of a domain or topic. The first data set is transformed by one or more of altering a phrase, adding a word or phrase, deleting a word or phrase, inserting an unrelated word or phrase, or removing an unrelated word or phrase to create a modified training set. The neural network is then trained on the first data set and the modified training set and a set of incorrect words or phrases that are either wrong or irrelevant to the first data set. Another training set is created comprising the first data set, the modified training set, and the incorrect words or phrases and utilized to train the neural network in a second training stage.

In another embodiment, first agent 208 and/or second agent 218 may be instantiated and self-inspect for domains. For example, first agent 208 may comprise a neural network and, upon instantiation and/or periodically, ask itself what it knows or what its attributes are. First agent 208 and/or second agent 218 then generates a response which is then reported to and utilized by agent discovery service 214. As a result, agents (human or automated) may submit a query to agent discover service 214 and, if appropriate, route a call to first agent 208, second agent 218, or another second agent (not shown).

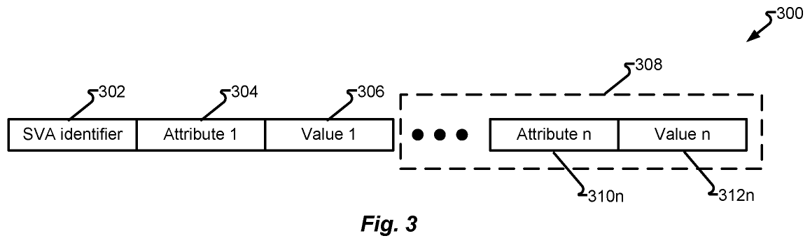

FIG. 3 depicts data structure 300 in accordance with embodiments of the present disclosure. In one embodiment, data structure 300 comprises a specialized virtual agent (SVA) identifier 302, such as an address on a network, index, or other identifier to indicate a particular specialized virtual agent. Data structure 300 comprises attribute 1 field 304 identifying a particular attribute (e.g., cost, current cost, domain, security level, wait time, etc.) and corresponding value 1 field 306 (e.g., 50.03/minute, “customer mailing address collection”, secure for private data, 3.14 seconds, etc.). Data block 308 comprises one or more additional attribute and value pairs, such as attribute n 310n and corresponding value n 312n. Data structure 300 may be maintained in data storage 210, 216, 220, and/or another data storage component.

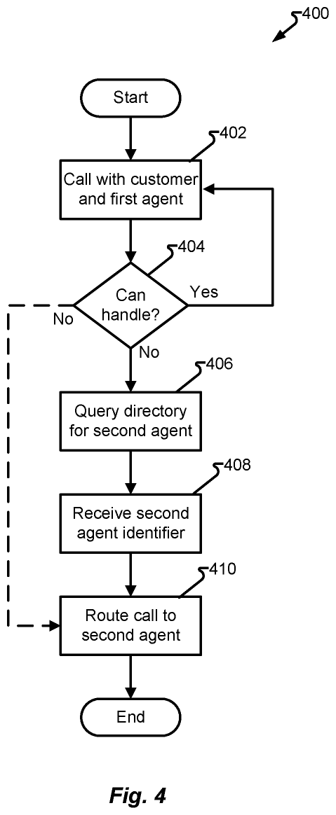

FIG. 4 depicts process 400 in accordance with embodiments of the present disclosure. In one embodiment, process 400 is embodied as machine-readable instructions maintained in a non-transitory memory that when read by a machine, such as a processor of a server, cause the machine to execute the instructions and thereby execute process 400. The processor of the server may include, but is not limited to, at least one processor of a server executing one or more of first agent 208, second agent 218, agent discovery service 214, and/or another server.

In one embodiment, process 400 begins and, in step 402, a call is processed by a first agent, such as first agent 208. Next, test 404 determines if the first agent can handle the call. For example, first agent may be a call routing agent and be unable to handle any call beyond an initial greeting or assessment. In another embodiment, the first agent may be able to process the call up to a point but be unable to continue, such as when customer 202, utilizing device 204, changes the topic. Test 404 may be determined in the affirmative any time the call includes a domain or other attribute not specifically identified for the first agent (e.g., such as a record in data storage 216 and conforming to data structure 300). If test 404 is determined in the affirmative, process 400 loops back to step 402 until the call terminates or test 404 is determined in the negative.

Optionally, test 404, when determined in the negative, is aware of the target second agent and, in step 410, routes the call thereto. In another embodiment, test 404 is determined in the negative and the target second agent is not yet known. Accordingly, step 406 queries a directory service, such as agent discovery service 214, and receives a response including a second agent identifier in step 408. In step 410, the call is then routed to the identified second agent from step 408.

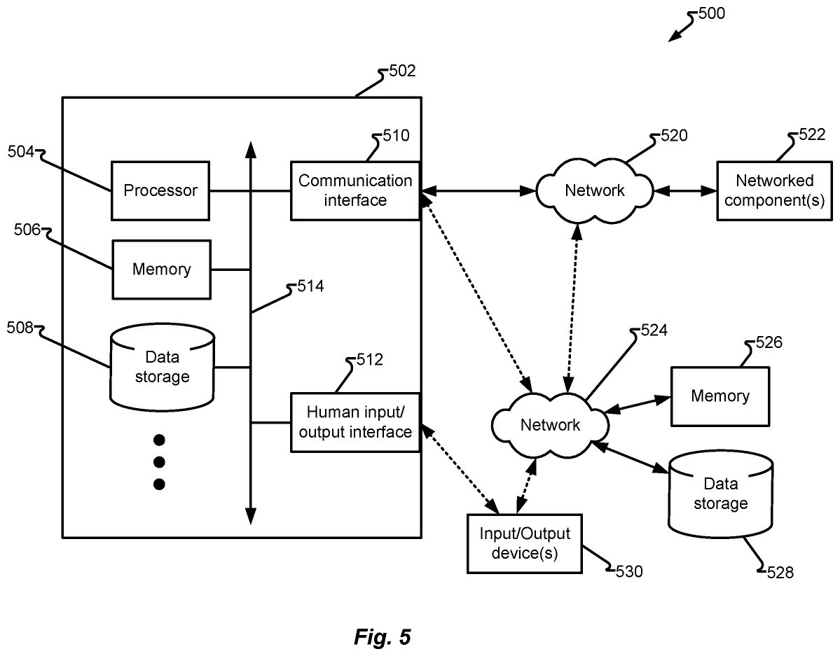

FIG. 5 depicts device 502 in system 500 in accordance with embodiments of the present disclosure. In one embodiment, first agent 208, second agent 218, and/or agent discovery service 214 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 104 and/or network 212 may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization, such as contact center 102, whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. For example, a connection between one particular customer, using a particular customer communication device 108, may be enabled (or disabled) with a particular networked component 522 and/or particular resource 112. Similarly, one particular networked component 522 and/or resource 112 may be enabled (or disabled) from communicating with a particular other networked component 522 and/or resource 112, including, in certain embodiments, device 502 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface to a communications network; and
at least one processor coupled with a computer memory comprising computer-readable instructions; and
wherein the at least one processor executes the computer-readable instructions to:
execute a first specialized virtual agent comprising a first set of abilities;
execute a second specialized virtual agent comprising a second set of abilities comprising at least one ability of the second set of abilities absent from at least one ability of the first set of abilities;
engage the first specialized virtual agent in a communication, via the network interface, with a customer communication device utilized by a customer, wherein the communication comprises content provided by the customer corresponding to a work item; and
upon determining that the first set of abilities is absent a required ability that is required to resolve the work item, transfer the communication to the second specialized virtual agent.

2. The system of claim 1, wherein the at least one processor executes the computer-readable instructions to further determine that the required ability matches at least one ability of the second set of abilities.

3. The system of claim 2, wherein the at least one processor executes the computer-readable instructions to further:
execute a third specialized virtual agent comprising a third set of abilities, wherein at least one ability of the third set of abilities is absent from both the first set of abilities and the second set of abilities; and
wherein transfer of the communication to the second specialized virtual agent is performed upon determining a better degree of match between the required ability to at least one ability of the second set of abilities compared to a degree of match between the required ability and the third set of abilities.

4. The system of claim 1, wherein the first set of abilities differ from the second set of abilities in at least one ability shared between the first set of abilities and the second set of abilities differ in complexity.

5. The system of claim 1, wherein the first set of abilities differ from the second set of abilities in at least one of available computational cycles, memory, bandwidth, or processing speed.

6. The system of claim 1, wherein transferring the communication to the second specialized virtual agent further comprises instantiating the second specialized virtual agent and transferring the communication to the second specialized virtual agent thereafter.

7. The system of claim 1, wherein the at least one processor executes the computer-readable instructions to:
execute a virtual agent discovery service; and
determine, by the virtual agent discovery service, that the required ability to resolve the work item is present in a data record of abilities corresponding to the second specialized virtual agent.

8. The system of claim 1, wherein the at least one processor executes the computer-readable instructions to:
execute a virtual agent discovery service coupled with a data storage to maintain the second set of abilities; and
determine, by the virtual agent discovery service, that the required ability is present in the second set of abilities transferring the communication to a default agent.

9. The system of claim 1, wherein the first set of abilities and the second set of abilities comprise at least one of domain knowledge ability, product knowledge ability, technical skill ability, language ability, communication type ability, secure communication ability, and wait time.

10. A method, comprising:
executing a first specialized virtual agent comprising a first set of abilities;
executing a second specialized virtual agent comprising a second set of abilities comprising at least one ability of the second set of abilities absent from at least one ability of the first set of abilities;
engaging the first specialized virtual agent in a communication, via a network, with a customer communication device utilized by a customer, wherein the communication comprises content provided by the customer corresponding to a work item; and
upon determining that the first set of abilities is absent a required ability that is required to resolve the work item, transferring the communication to the second specialized virtual agent.

11. The method of claim 10, further comprising determining that the required ability matches at least one ability of the second set of abilities.

12. The method of claim 11, further comprising:
executing a third specialized virtual agent comprising a third set of abilities, wherein at least one ability of the third set of abilities is absent from both the first set of abilities and the second set of abilities; and
wherein transfer of the communication to the second specialized virtual agent is performed upon determining a better degree of match between the required ability to at least one ability of the second set of abilities compared to a degree of match between the required ability and the third set of abilities.

13. The method of claim 10, wherein the first set of abilities differs from the second set of abilities in at least one ability shared between the first set of abilities and the second set of abilities differ in complexity.

14. The method of claim 10, wherein the first set of abilities differ from the second set of abilities in at least one of available computational cycles, memory, bandwidth, or processing speed.

15. The method of claim 10, wherein transferring the communication to the second specialized virtual agent further comprises instantiating the second specialized virtual agent and, thereafter, transferring the communication to the second specialized virtual agent.

16. The method of claim 10, further comprising:
executing a virtual agent discovery service; and
determining, by the virtual agent discovery service, that the required ability to resolve the work item is present in a data record of abilities corresponding to the second specialized virtual agent.

17. The method of claim 10, further comprising:
executing a virtual agent discovery service coupled with a data storage to maintain the second set of abilities; and
determining, by the virtual agent discovery service, that the required ability is present in the second set of abilities transferring the communication to a default agent.

18. The method of claim 10, wherein the first set of abilities and the second set of abilities comprise at least one of domain knowledge ability, product knowledge ability, technical skill ability, language ability, communication type ability, secure communication ability, and wait time.

19. A computer-readable medium having instructions encoded thereon comprising instructions to:
execute a first specialized virtual agent comprising a first set of abilities;
execute a second specialized virtual agent comprising a second set of abilities comprising at least one ability of the second set of abilities absent from at least one ability of the first set of abilities;
engage the first specialized virtual agent in a communication, via a network, with a customer communication device utilized by a customer, wherein the communication comprises content provided by the customer corresponding to a work item; and
upon determining that the first set of abilities is absent a required ability that is required to resolve the work item, transfer the communication to the second specialized virtual agent.

20. The computer-readable medium of claim 19, further comprising instructions to:
execute a virtual agent discovery service; and
determine, by the virtual agent discovery service, that the required ability to resolve the work item is present in a data record of abilities corresponding to the second specialized virtual agent.
